(19) United States
(12) Patent Application Publication
(10) Pub. No.: US 2024/0388360 A1
(43) Pub. Date: Nov. 21, 2024

(54) APPARATUS AND METHOD FOR NON-TERRESTRIAL NETWORKS

(71) Applicant: Nokia Technologies Oy, Espoo (FI)

(72) Inventors: Mads LAURIDSEN, Aalborg (DK); Sandra HOPPE, Munich (DE); Ayaz AHMED, Bangalore (IN); Jedrzej STANCZAK, Wroclaw (PL)

(21) Appl. No.: 18/574,664

(22) PCT Filed: Jul. 13, 2022
(86) PCT No.: PCT/EP2022/069571

§ 371 Date: Dec. 27, 2023

(30) Foreign Application Priority Data
Aug. 2, 2021 (IN) 202141034710

(51) Int. Cl. H04B 7/185

(52) U.S. Cl. CPC H04B 7/1855; H04B 7/18513

(57) ABSTRACT

The present invention discloses an apparatus, for use by a cell in a non-terrestrial network, comprising means for performing transmitting, to a user equipment, information indicating ephemeris corresponding to the cell and information indicating ephemeris corresponding to at least one neighboring cell, wherein the neighboring cell is detectable at the user equipment when the user equipment is in coverage of said cell.

### FIELD OF THE INVENTION

Various example embodiments relate to communication technologies, specifically to Non-Terrestrial Networks.

### BACKGROUND

A non-terrestrial network (NTN) refers to a network, or segment of networks using radio frequency (RF) resources on board a satellite.

One of the main deployment scenario is using low-earth orbit (LEO) satellites at altitudes of 600 km to 1200 km in a transparent architecture to facilitate communication between user equipment (UE) and a base station on Earth. It is also expected to include the regenerative architecture, where the base station is on board the satellite.

The LEO scenario is significantly different from terrestrial networks and other non-terrestrial network scenarios, because the communication distance and thus propagation delays are longer, and furthermore the satellites move at a speed of about 7.5 km/s relative to Earth. According to TR 38.821, the Doppler shift, which is caused by the high-speed movement of the satellites, is 21-24 ppm in LEO scenario, i.e. about 45 kHz for deployment in the 2 GHz S-band.

In order to enable the UE to pre-compensate the Doppler shift (both for uplink and downlink) such that the receiver is not affected by the high Doppler shift, the UE needs to have knowledge about the satellite movement.

Meanwhile, due to the fast satellite movement, the UE will frequently experience that a new cell provides coverage in the area of the UE. To facilitate mobility, the UE needs to perform neighboring cell measurements.

Neighboring cell measurements at the UE requires the ephemeris of the satellite, which is providing coverage of the neighboring cell. Such ephemeris is likely obtained through system information broadcast (SIB), which leads to a chicken-and-egg problem, because the UE needs the ephemeris to do pre-compensation to obtain the SIB containing the ephemeris.

### SUMMARY OF THE INVENTION

Amongst others, it is an object of embodiments of the present disclosure to enable Doppler pre-compensation of neighboring cell and to obtain ephemeris corresponding to neighboring cells in NTN.

This object is achieved, according to a first example aspect of the present disclosure, by an apparatus, for use by a cell in a non-terrestrial network, comprising means for performing: transmitting, to a user equipment, information indicating ephemeris corresponding to the cell and information indicating ephemeris corresponding to at least one neighboring cell, wherein the neighboring cell is detectable at the user equipment when the user equipment is in coverage of said cell.

In one embodiment, coverage of said cell and the neighboring cell is provided by satellite(s) that is (are) moving with respect to the Earth's surface, particularly by Low-Earth Orbit satellite(s).

In one embodiment, the information indicating ephemeris corresponding to the cell and the information indicating ephemeris corresponding to at least one neighboring cell is transmitted through system information broadcast.

In one embodiment, coverage of at least one of the neighboring cell is provided by satellite(s) on same orbit as said cell, and wherein the ephemeris corresponding to said at least one of the neighboring cell is indicated in reference with respect to the ephemeris corresponding to said cell.

In one embodiment, coverage of said cell and a first neighboring cell is provided by the same satellite, and the ephemeris corresponding to the first neighboring cell is indicated as same as ephemeris corresponding to said cell.

In one embodiment, coverage of said cell and a second neighboring cell is provided by different satellites on the same orbit, and the ephemeris corresponding to the second neighboring cell is indicated as the ephemeris corresponding to said cell with an offset related to orbital inter-satellite distance.

In one embodiment, coverage of said cell is provided by a satellite on a first orbit, coverage of a third neighboring cell and a fourth neighboring cell is provided by satellite(s) on a second orbit, and wherein, the ephemeris corresponding to the fourth neighboring cell is indicated in reference to the ephemeris corresponding to the third neighboring cell.

In one embodiment, the coverage of the third neighboring cell and the fourth neighboring cell is provided by same satellite on the second orbit, and wherein, the ephemeris corresponding to the fourth neighboring cell is indicated as same as the ephemeris corresponding to the third neighboring cell.

In one embodiment, the coverage of the third neighboring cell and the fourth neighboring cell is provided by different satellites on the second orbit, and wherein, the ephemeris corresponding to the fourth neighboring cell is indicated as the ephemeris corresponding to the third neighboring cell with an offset related to orbital inter-satellite distance.

In one embodiment, the means comprises: at least one processor; and at least one memory including computer program code, the at least one memory and computer program code configured to, with the at least one processor, cause the performance of the apparatus.

According to a second aspect of the present disclosure, there is provided an apparatus, for use by a user equipment in a non-terrestrial network, comprising means for performing: receiving, from a cell in the non-terrestrial network, information indicating ephemeris corresponding to the cell and information indicating ephemeris corresponding to at least one neighboring cell, wherein the neighboring cell is detectable at the user equipment when the user equipment is in coverage of said cell; determining Doppler shift estimate for at least one of said neighboring cell based on the received information indicating respective ephemeris.

In one embodiment, the means are further configured for: determining Doppler shift estimate for at least one of said neighboring cell by reusing the ephemeris corresponding to the cell or applying an offset to the ephemeris corresponding to the cell, based on the received information indicating respective ephemeris.

In one embodiment, the means are further configured for: pre-compensating Doppler shift for respective one of the at least one of said neighboring cell, based on the respective Doppler shift estimate; receiving and measuring Synchronization Signal/Physical Broadcast Channel block from the respective one of the at least one of said neighboring cell for assessing signal level and/or signal quality of the respective neighboring cell.

According to a third aspect of the present disclosure, there is provided a method, for use by a cell in a non-terrestrial network, comprising: transmitting, to a user equipment, information indicating ephemeris corresponding to the cell and information indicating ephemeris corresponding to at least one neighboring cell, wherein the neighboring cell is detectable at the user equipment when the user equipment is in coverage of said cell.

According to a fourth aspect of the present disclosure, there is provided a method, for use by a user equipment in non-terrestrial networks, comprising: receiving, from a cell in the non-terrestrial network, information indicating ephemeris corresponding to the cell and information indicating ephemeris corresponding to at least one neighboring cell, wherein the neighboring cell is detectable at the user equipment when the user equipment is in coverage of said cell; determining Doppler shift estimate for said at least one neighboring cell based on the received information indicating respective ephemeris.

The various example embodiments of the first example aspect may be applied as example embodiments to the other example aspects.

According to the various embodiments, ephemeris corresponding to neighboring cells is transmitted by the serving cell or source cell. It is thus possible for the UE to pre-compensate the Doppler shift and further be able to perform measurements of other cells based on their reference signals.

### BRIEF DESCRIPTION OF THE FIGURES

For a more complete understanding of example embodiments of the present invention, reference is now made to the following descriptions taken in connection with the accompanying drawings in which:

FIG. 1 shows a part of an exemplifying communication network in which examples of disclosed embodiments may be applied;

FIG. 2 shows an example signaling diagram according to an example embodiment.

FIG. 3 shows example behaviour of an apparatus for use by a UE 110 according to an example embodiment;

FIG. 4 shows a block diagram depicting an example computing system for implementing various aspects of the present disclosure.

Same or similar reference numerals refer to same or similar parts, components or method steps.

### DETAILED DESCRIPTION

Example embodiments of the present application are described herein in detail and shown by way of example in the drawings. It should be understood that, although specific embodiments are discussed herein there is no intent to limit the scope of the invention to such embodiments. To the contrary, it should be understood that the embodiments discussed herein are for illustrative purposes, and that modified and alternative embodiments may be implemented without departing from the scope of the invention as defined in the claims. The sequence of method steps is not limited to the specific embodiments, the method steps may be performed in other possible sequence. Similarly, specific structural and functional details disclosed herein are merely representative for purposes of describing the embodiments. The invention described herein, however, may be embodied in many alternate forms and should not be construed as limited to only the embodiments set forth herein.

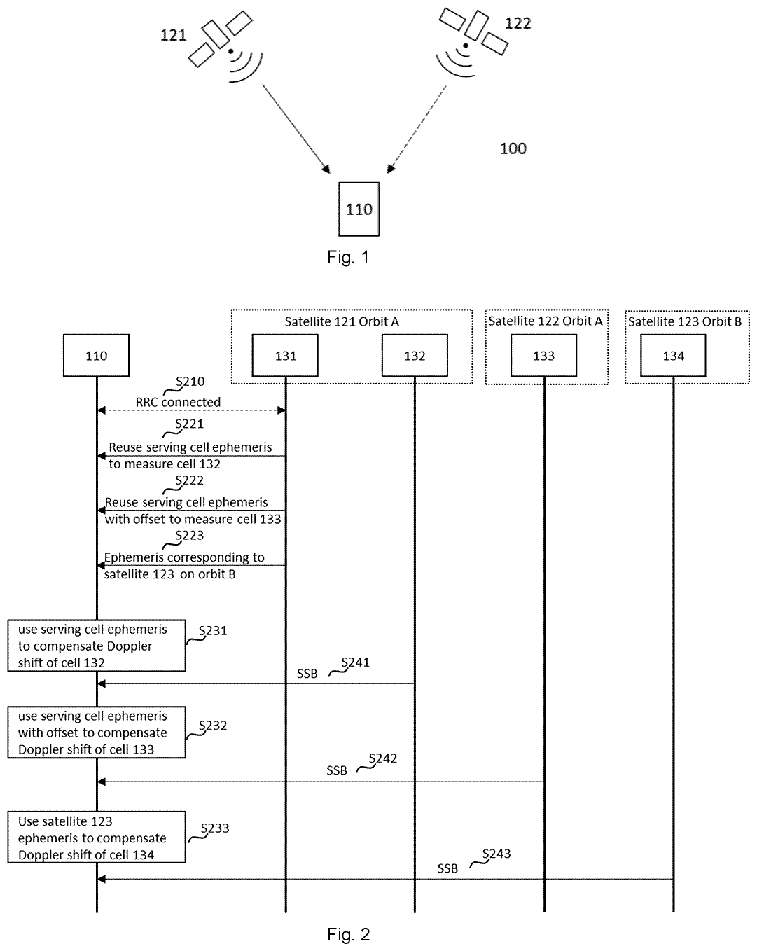

FIG. 1 shows a part of an exemplifying communication network in which examples of disclosed embodiments may be applied.

As shown in FIG. 1, at least part of the non-terrestrial network 100 is implemented using RF resources on board satellites 121 and 122. The satellites 121 and 122 are moving with respect to the Earth's surface. Particularly, in one embodiment, the satellites 121 and 122 are Low-Earth Orbit satellites. A skilled person shall understand the number of satellites shown in FIG. 1 is only for illustrative purpose only. In other embodiments, the non-terrestrial network 100 may comprise more or less satellites. In the following, the satellites 121 and 122 will be described as on same orbit (Orbit A). A skilled person shall understand that the satellites 121 and 122 may also be on different orbits.

In FIG. 1, the UE 110 in the non-terrestrial network 100 is time-frequency synchronized to a cell 131 (not shown), so that the UE 110 is able to receive message from the cell 131. The coverage of the cell 131 is provided by the satellite 121. In one example, the cell 131 may be on board the satellite 121. In another example, the cell 131 may be conveyed through the satellite 121. The synchronization of the UE 110 and the serving cell 131 may be carried out based on Synchronization Signal/Physical Broadcast Channel (SS/PBCH) block transmitted by the cell 131. A skilled person should also know other procedures to achieve the synchronization of the UE 110 and the serving cell 131. For simplicity, it will not be further elaborated here. In the following, the cell 131 may also be named as serving cell 131 or source cell 131.

There are neighboring cells detectable at the UE 110 when the UE 110 is in coverage of the cell 131. Due to the fast satellite movement, it may be necessary for the UE 110 to switch to one of the neighboring cells. Prior to that switch, the UE 110 needs to perform neighboring cell measurements, for example based on a reference signal, to determine if the cell reselection or handover criteria are met and the whether the UE 110 shall change the cell. If so, the UE 110 may further select one of the neighboring cells as target cell, and further establish connection with the target cell. In one example, the UE may compare the signal level or quality of the neighbouring cells with signal level or quality of the serving cell 131. All the cells are measured based on reference signals (e.g. SSBs). If signal level or quality of the neighbouring cells is stronger or better, the UE 110 may take some actions, such as handover or cell reselection. The procedure of selecting a target cell is known to a skilled person and thus will not be described here in detail.

FIG. 2 shows an example signaling diagram according to an example embodiment.

In the example shown in FIG. 2, the coverage of a first neighboring cell 132 may also be provided by the satellite 121, for example per different or same beam. The coverage of a second neighboring cell 133 may be provided by the satellite 122 on the same orbit, Orbit A, as the satellite 121. The coverage of a third neighboring cell 134 may be provided by a further satellite 123 (not shown) on a different orbit, Orbit B.

In the example shown in FIG. 2, there are multiple neighboring cells. However, a skilled person shall understand that the number of neighboring cells is not limited to the given example. It is also possible to have less or more neighboring cells at certain moment.

In FIG. 2, the UE 110 is in coverage of the cell 131, or camped on the cell 131. The UE 110 may establish Radio Resource Control (RRC) connection with the serving cell 131 in step S210. A skilled person shall understand that the step S210 is not essential. In another example, the UE 110 may also be in RRC idle or inactive state. For example, the UE 110 may be time-frequency synchronized to the serving cell 131, so that the UE 110 is able to receive message, for example system information, from the serving cell 131.

Generally, the serving cell 131 transmits to the UE 110 information indicating ephemeris corresponding to the serving cell 131 and information indicating ephemeris corresponding to at least one neighboring cell. A skilled person should understand that the ephemeris defines the satellite's current position and short-term future movement, either through a vector or orbital parameters.

The ephemeris may be indicated in any format. One example ephemeris format is based on satellite position and velocity state vectors. Another example ephemeris format is based on orbital elements. The cell 131 may obtain information related to neighboring cell (e.g. ID and/or corresponding ephemeris) from other entity in the NTN network.

In one embodiment, the information indicating ephemeris corresponding to the serving cell 131 and the information indicating ephemeris corresponding to at least one neighboring cell is transmitted through system information broadcast (SIB). Additionally or alternatively, the information indicating ephemeris corresponding to the serving cell 131 and the information indicating ephemeris corresponding to at least one neighboring cell is transmitted together with Synchronization Signal/Physical Broadcast Channel block Measurement Time Configuration (SMTC).

After the UE 110 receives the information indicating ephemeris corresponding to the serving cell 131 and information indicating ephemeris corresponding to at least one neighboring cell, the UE 110 determines Doppler shift estimate for said at least one neighboring cell based on the received information indicating respective ephemeris.

Specifically, in one embodiment shown in FIG. 2, in step S221, the serving cell 131 may indicate the UE 110 to reuse the ephemeris corresponding to the serving cell 131 to measure the first neighboring cell 132.

Then in step S231, the UE 110 may reuse the ephemeris corresponding to the serving cell 131 to determine Doppler shift estimate for the first neighboring cell 132. After the Doppler shift for the first neighboring cell 132 is pre-compensate based on the Doppler shift estimate, in step S241, the UE 110 may receive and measure Synchronization Signal/Physical Broadcast Channel block (SSB) from the first neighboring cell 132 for assessing signal level and/or signal quality of the first neighboring cell 132.

Still referring to FIG. 2, in another embodiment, in step S222, the serving cell 131 may indicate the UE 110 to reuse the ephemeris corresponding to the serving cell 131 with an offset X related to orbital inter-satellite distance to measure the second neighboring cell 133. For example, the serving cell 131 may indicate the UE 110 to reuse the ephemeris corresponding to the serving cell 131 starting at time T-X, wherein, T is current time and the offset X is related to orbital inter-satellite distance.

Specifically, in one example, the offset X may be derived from satellite location and satellite movement speed, for example, coordinates (x,y,z), and velocity vector (vx,vy,vz). In another example, the offset X may be derived from the number of satellites in orbit. In yet further example, the offset X may be provided as time information of when the ephemeris corresponding to the serving cell 131 is valid for the second neighboring cell 133. For example, the ephemeris corresponding to the serving cell 131 valid at time T1 is valid for the second neighboring cell 133 at time T2.

Alternatively, the offset X may be determined by the UE 110. For example, the serving cell 131 may transmit satellite location together with satellite movement speed to the UE 110. The UE 110 may then determine the inter-satellite distance and thus the offset X based on the satellite coordinates (x,y,z) and velocity vector (vx,vy,vz). In another example, the serving cell 131 may transmit number of satellites in orbit to the UE 110. The UE 110 may then determine the inter-satellite distance and or timing and thus the offset X, based on the number of satellites per orbit and the orbit circumference.

Then in step S232, the UE 110 may apply the offset X to the ephemeris corresponding to the serving cell 131 to determine Doppler shift estimate for the second neighboring cell 133. After the Doppler shift for the second neighboring cell 133 is pre-compensate based on the Doppler shift estimate, in step S242, the UE 110 receives and measures SSB burst(s) from the second neighboring cell 133 for assessing signal level and/or signal quality of the second neighboring cell 133.

Furthermore, while determining the Doppler shift estimate, the UE 110 may also handle the earth rotation compensation by complementing with an offset.

According to the embodiments above, the coverage of the first and second neighboring cell 132 and 133 are provided by satellites on same orbit as the serving cell 131, the ephemeris corresponding to the first and second neighboring cell 132 and 133 may be indicated in reference with respect to the ephemeris corresponding to the serving cell 131.

Indicating the ephemeris corresponding to a neighboring cell by reference to the ephemeris corresponding to the serving cell has the following advantages: it allows the UE to pre-compensate and measure the neighboring cell faster by using the ephemeris corresponding to the serving cell as a baseline. Reusing the ephemeris corresponding to the serving cell may also facilitate a simpler cell search because the UE can reduce the time and frequency to search in. Furthermore, reuse of ephemeris by indication of shift reduces signaling overhead as compared to transmitting entire ephemeris for the neighboring cell. It also facilitates indication in SIB for RRC Idle/Inactive UEs.

Even though the ephemeris will not match 100% due to variations in satellite movement, it will bring the Doppler shift to a manageable level. In another example, if the neighboring cell's satellite's ephemeris is different from the serving cell's satellite's ephemeris, the network may provide a correction offset together with X.

In the examples above, the offset X is provided by the serving cell 131. Alternatively, in yet further examples, the UE may be able to determine the offset X or one of the related variables listed above, by observing multiple satellite passes.

In another embodiment shown in FIG. 2, in step S223, the serving cell 131 may indicate to the UE 110 the ephemeris corresponding to the satellite 123 on orbit B that is providing coverage of the third neighboring cell 134.

Then in step S233, the UE 110 may determine Doppler shift estimate for the third neighboring cell 134 based on the received ephemeris corresponding to the satellite 123. After the Doppler shift for the third neighboring cell 134 is pre-compensated based on the Doppler shift estimate, in step S243, the UE 110 receives and measures SSB burst(s) from the third neighboring cell 134 for assessing signal level and/or signal quality of the third neighboring cell 134.

The embodiments above may also be combined together. A skilled person shall understand that the number of neighboring cells is not limited to the given example.

In yet further embodiment, the coverage of a fourth neighboring cell 135 may be provided by the further satellite 123 or a yet further satellite 124 on the Orbit B. In that case, ephemeris corresponding to the fourth neighboring cell 135 may be indicated in reference to the ephemeris corresponding to the third neighboring cell 134.

For example, in one embodiment, the coverage of the third neighboring cell 134 and the fourth neighboring cell 135 is provided by same satellite 123 on the orbit B. In that case, the ephemeris corresponding to the fourth neighboring cell 135 may be indicated as same as the ephemeris corresponding to the third neighboring cell 134.

In another embodiment, the coverage of the third neighboring cell 134 and the fourth neighboring cell 135 is provided by different satellites 123 and 124 on the orbit B. In that case, the ephemeris corresponding to the fourth neighboring cell may be indicated as the ephemeris corresponding to the third neighboring cell 134 with an offset related to orbital inter-satellite distance.

Indicating the ephemeris corresponding to one cell by reference to the ephemeris corresponding to another cell sharing the same orbit may further reduce the signaling overhead.

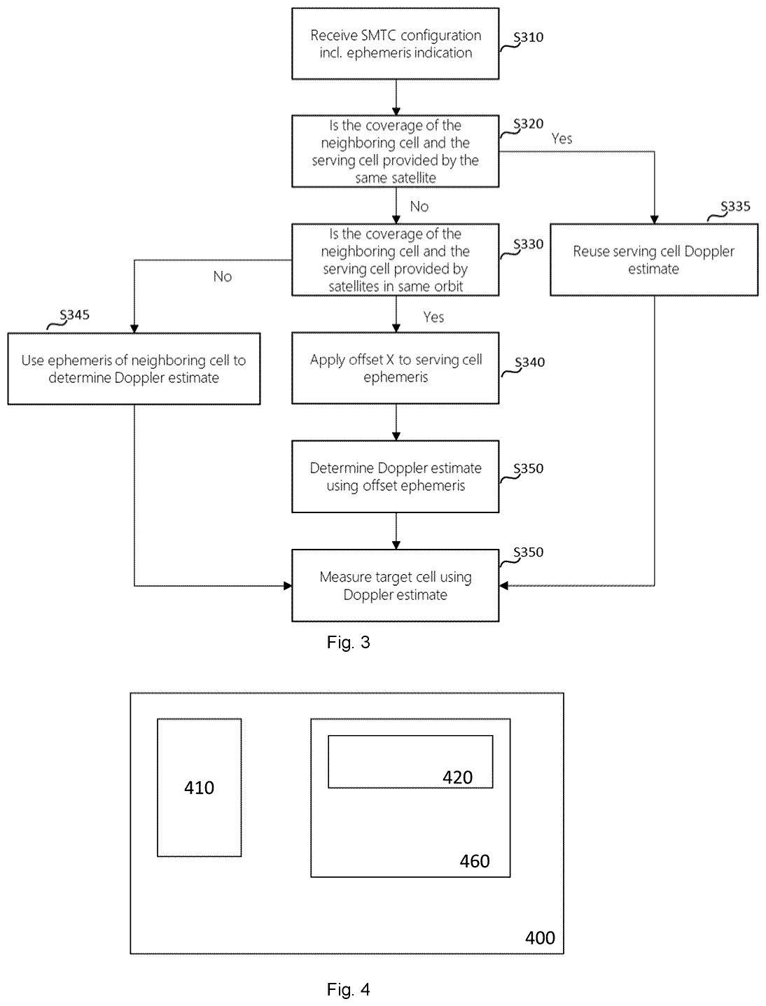

FIG. 3 shows example behaviour of an apparatus for use by a UE 110 according to an example embodiment.

As shown in FIG. 3, in step S310, the UE 110 receives SMTC configuration including ephemeris indication from the serving cell 131. In step S320, the UE 110 determines whether the coverage of the neighboring cell and the serving cell 131 is provided by the same satellite. In case the coverage of the neighboring cell and the serving cell 131 is provided by the same satellite, the UE 110 proceeds with step S335 and reuses Doppler estimate corresponding to the serving cell 131 as the Doppler estimate corresponding to the neighboring cell. In case the coverage of the neighboring cell and the serving cell 131 is provided by the different satellites, the UE 110 proceeds with step S330 and determines whether the coverage of the neighboring cell and the serving cell 131 is provided by satellites in same orbit.

In case the coverage of the neighboring cell and the serving cell 131 is provided by satellites in the same orbit, the UE 110 applies offset X to the ephemeris corresponding to the serving cell in step S340 and determines in step S350 the Doppler estimate corresponding to the neighboring cell based on the offset ephemeris. In case the coverage of the neighboring cell and the serving cell 131 is provided by satellites in different orbits, the UE 110 uses ephemeris of neighboring cell to determine the Doppler estimate for the neighboring cell in step S345.

After the Doppler estimate for the neighboring cell is determined in step S335, S350 or S345, the UE performs pre-compensation of the Doppler shift based on the determined Doppler shift estimate, in order to receive and measure SSB burst(s) from the respective neighboring cell for assessing signal level and/or signal quality of the respective neighboring cell in step S350.

FIG. 4 shows a block diagram depicting an example computing system 400.

The computing system 400 comprises means for performing, wherein the means for performing comprises at least one processor 410, at least one memory 460 including computer program code 420, the at least one memory 460 and the computer program code 420 configured to, with the at least one processor 410, cause the performance of the computing system 400. The computing system 400 may be materialized as, or may comprise, an Application Specific Integrated Circuit (ASIC), an Application Specific Instruction set Processor (ASIP), a Field Programmable Gate Array (FPGA), a Digital Signal Processor (DSP) based system or a combination thereof.

In the example of FIG. 4, the processor 410 is a control unit operatively connected to read from and write to the memory 460. The processor 410 may also be configured to receive control signals received via an input interface and/or the processor 410 may be configured to output control signals via an output interface. In an example embodiment the processor 410 may be configured to convert the received control signals into appropriate commands for controlling functionalities of the computing system 400. In other examples, the computing system 400 may comprise multiple processors.

The memory 460 stores computer program instructions 420 which when loaded into the processor 410 control the operation of the computing system 400 as explained below. In other examples, the computing system 400 may comprise more than one memory 460 or different kinds of storage devices.

Computer program instructions 420 for enabling implementations of example embodiments of the invention or a part of such computer program instructions may be loaded onto the computing system 400 by the manufacturer of the computing system 400, by a user of the computing system 400, or by the computing system 400 itself based on a download program, or the instructions can be pushed to the computing system 400 by an external device. The computer program instructions may arrive at the computing system 400 via an electromagnetic carrier signal or be copied from a physical entity such as a computer program product, a memory device or a record medium such as a Compact Disc (CD), a Compact Disc Read-Only Memory (CD-ROM), a Digital Versatile Disk (DVD) or a Blu-ray disk.

Such a computing system 400 is suitable for implementing the apparatus for use by a cell in a non-terrestrial network according to various embodiments of the present disclosure. More specifically, the program code performs the step of: transmitting, to a user equipment, information indicating ephemeris corresponding to the cell and information indicating ephemeris corresponding to at least one neighboring cell, wherein the neighboring cell is detectable at the user equipment when the user equipment is in coverage of said cell.

Furthermore, the computing system 400 is also suitable for implementing the apparatus for use by a user equipment in a non-terrestrial network according to various embodiments of the present disclosure. More specifically, the program code performs the steps of: receiving, from a cell in the non-terrestrial network, information indicating ephemeris corresponding to the cell and information indicating ephemeris corresponding to at least one neighboring cell, wherein the neighboring cell is detectable at the user equipment when the user equipment is in coverage of said cell; determining Doppler shift estimate for said at least one neighboring cell based on the received information indicating respective ephemeris.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the scope of the claims are therefore intended to be embraced therein.

It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1.-15. (canceled)

16. An apparatus of a non-terrestrial network, comprising at least one processor and at least one memory including a computer program code, wherein the at least one memory and the computer program code are configured, with the at least one processor, to cause the apparatus at least to:
transmit, to a user equipment, information indicating ephemeris corresponding to the cell and information indicating ephemeris corresponding to at least one neighboring cell.

17. The apparatus according to claim 16, wherein, coverage of said cell and the neighboring cell is provided by at least one satellite that is moving with respect to the Earth's surface.

18. The apparatus according to claim 16, wherein, the information indicating ephemeris corresponding to the cell and the information indicating ephemeris corresponding to at least one neighboring cell is transmitted through system information broadcast.

19. The apparatus according to claim 16, wherein coverage of at least one of the neighboring cell is provided by at least one satellite on same orbit as said cell, and wherein the ephemeris corresponding to said at least one of the neighboring cell is indicated in reference with respect to the ephemeris corresponding to said cell.

20. The apparatus according to claim 16, wherein, coverage of said cell and a first neighboring cell is provided by the same satellite, and the ephemeris corresponding to the first neighboring cell is indicated as same as ephemeris corresponding to said cell.

21. The apparatus according to claim 16, wherein, coverage of said cell and a second neighboring cell is provided by different satellites on the same orbit, and the ephemeris corresponding to the second neighboring cell is indicated as the ephemeris corresponding to said cell with an offset related to orbital inter-satellite distance.

22. The apparatus according to claim 16, wherein, coverage of said cell is provided by a satellite on a first orbit, coverage of a third neighboring cell and a fourth neighboring cell is provided by at least one satellite on a second orbit, and wherein, the ephemeris corresponding to the fourth neighboring cell is indicated in reference to the ephemeris corresponding to the third neighboring cell.

23. The apparatus according to claim 22, wherein the coverage of the third neighboring cell and the fourth neighboring cell is provided by different satellites on the second orbit, and wherein, the ephemeris corresponding to the fourth neighboring cell is indicated as the ephemeris corresponding to the third neighboring cell with an offset related to orbital inter-satellite distance.

24. The apparatus according to claim 22, wherein the coverage of the third neighboring cell and the fourth neighboring cell is provided by same satellite on a second orbit, and wherein, the ephemeris corresponding to the fourth neighboring cell is indicated as same as the ephemeris corresponding to the third neighboring cell.

25. An apparatus for use by a user equipment in a non-terrestrial network, comprising at least one processor and at least one memory including a computer program code, wherein the at least one memory and the computer program code are configured, with the at least one processor, to cause the apparatus at least to:
receive, from a cell in the non-terrestrial network, information indicating ephemeris corresponding to the cell and information indicating ephemeris corresponding to at least one neighboring cell;
determine Doppler shift estimate for at least one of said at least one neighboring cell based on the received information indicating respective ephemeris.

26. The apparatus according to claim 25, wherein the at least one memory and the computer program code are configured, with the at least one processor, to cause the apparatus further to:
determine Doppler shift estimate for at least one of said at least one neighboring cell by reusing the ephemeris corresponding to the cell or by applying an offset to the ephemeris corresponding to the cell, based on the received information indicating respective ephemeris.

27. The apparatus according to claim 25, wherein the at least one memory and the computer program code are configured, with the at least one processor, to cause the apparatus further to:
pre-compensate Doppler shift for respective one of said at least one neighboring cell, based on the respective Doppler shift estimate;
receive and measure Synchronization Signal/Physical Broadcast Channel block from the respective one of said at least one neighboring cell for assessing at least one of signal level or signal quality of the respective neighboring cell.

28. A method for use by a user equipment in non-terrestrial networks, comprising:
receiving, from a cell in the non-terrestrial network, information indicating ephemeris corresponding to the cell and information indicating ephemeris corresponding to at least one neighboring cell, wherein the neighboring cell is detectable at the user equipment when the user equipment is in coverage of said cell;
determining Doppler shift estimate for said at least one neighboring cell based on the received information indicating respective ephemeris.

29. The method according to claim 28, the method further comprising:
determining Doppler shift estimate for at least one of said at least one neighboring cell by reusing the ephemeris corresponding to the cell or by applying an offset to the ephemeris corresponding to the cell, based on the received information indicating respective ephemeris.

30. The method according to claim 28, the method further comprising:
pre-compensating Doppler shift for respective one of said at least one neighboring cell, based on the respective Doppler shift estimate;
receiving and measuring Synchronization Signal/Physical Broadcast Channel block from the respective one of said at least one neighboring cell for assessing at least one of signal level or signal quality of the respective neighboring cell.
